(19) United States
(12) Patent Application Publication
(10) Pub. No.: US 2013/0231757 A1
(43) Pub. Date: Sep. 5, 2013

(54) DEVICE WITH AUGMENTED REALITY

(71) Applicant: WEBER MASCHINENBAU GMBH BREIDENBACH, Breidenbach (DE)

(72) Inventor: Ingo Rother, Breidenbach (DE)

(73) Assignee: WEBER MASCHINENBAU GMBH BREIDENBACH, Breidenbach (DE)

(21) Appl. No.: 13/763,011

(22) Filed: Feb. 8, 2013

(30) Foreign Application Priority Data
Feb. 10, 2012 (DE) 102012002657.9

(51) Int. Cl. G05B 15/02

(52) U.S. Cl. CPC G05B 15/02
USPC 700/83

(57) ABSTRACT

The invention relates to a device for processing and/or transporting food products. The device comprises an operating element (8) controlling the device (1), the position of the operating element (8) relative to the device (1) being variable. The invention is characterized in that the current position and/or the orientation of the operating element (8) relative to the device (1) can be detected by a position detection device (15a), and that information (19) for the operation and/or diagnosis of the device (1) can be displayed to a user by the operating element (8) depending on the determined position.

The invention relates to a device for processing and/or transporting food products according to the preamble of claim 1 and to a method for operating such a device according to claim 14.

For example, from DE 2004 062 393 A1, a food-processing device is known which can be controlled by means of an operating element. From practice, further applications are known where the position of the operating element relative to the device can be varied.

Such devices have such complex designs that numerous complex elements and settings must be surveyed for their operation.

From US 2005/0021281 A1, a system is known which is intended to support the user of a production plant in the installation, operation, or maintenance by means of accompanying information, a so-called augmented reality. The system described therein comprises data glasses with a first camera. The user wearing the data glasses directs the camera to the production machine to record images of the latter. The position of the camera is determined by a computer system and information on the production machine are overlaid into the glasses for the wearer of the data glasses. A disadvantage of this system is that it employs numerous cost-intensive components to supply the user with information on the production machine.

It is the object of the present invention to provide a device for processing food in which an intuitive operation of the device is possible with constructively preferably simple means.

This object is achieved by a device having the features of claim 1 and by a method for the operation of such a device according to claim 14. Advantageous further embodiments of the invention are stated in the subclaims.

The device according to the invention is characterized in that the current position and/or the orientation of the operating element relative to the device can be detected by means of a position detection device, and that information for the operation and/or diagnosis of the device can be displayed to a user by the operating element depending on the detected position. The use of a position detection device for detecting the position and/or orientation of the operating element offers the advantage that no computation-bound image processing is required as in position detection by image comparison.

It is particularly advantageous if the operating element can represent the information to the user visually and/or audibly and/or sensibly. This permits a particularly intuitive operation of the device because several senses of the user can be addressed. It is conceivable to represent only certain information visually, others in contrast only audibly, and further information only sensibly. The combined addressing of several senses, for example to point out particularly important information, is also possible.

To be able to survey, diagnose or operate a major area of the food-processing production process, it can be advantageous for the operating element to be adapted for communication with further food-processing devices. It is, for example, conceivable that with one and the same operating element, a transport system arranged at the beginning of the production line, a subsequent cutting machine and a following subsequent packaging machine are operated and/or monitored and/or diagnosed. Advantageously, the operating element and/or the device itself is/are adapted for bidirectional communication with these further devices of the production process.

Preferably, the operating element can be employed in different machine types for processing food, mainly in slicers, food robots, automatic inserters, peelers and skinners. In particular in these machines, the operating element permits an improved operation control.

It revealed to be particularly advantageous for the operating element to be stationarily mounted at the device and the operating element to be pivoting and/or rotating relatively to the device. Thus, the position detection device can be arranged directly at the device and/or the operating element, permitting a particularly simple and inexpensive design of the information system. Thereby, a cable connection between the device and the operating element is sufficient.

It is suitable for the operating element to further comprise a display panel by which at least two different images can be simultaneously displayed. Such a display panel can be constructively easily integrated into the operating element.

A particularly advantageous variant of the invention provides for the display panel to be a touch-sensitive monitor for simultaneous image display and user input. This permits a particularly intuitive, user-friendly operation of the operating element and the complete device by the user. Moreover, further components of the operating element can be eliminated.

It is particularly suitable if in a first image of the display panel, an image of the device or of components of the device can be displayed, and the information about the device can be represented in a second image. The first and the second images can be represented one next to the other or superposed. This means that the image planes of the first and the second images superpose each other.

By a movement of the operating element towards a certain component and/or assembly of the device, the component and/or assembly can be preferably displayed in a first image plane on the display panel of the operating element, where in a second image plane, settings and/or other information pertaining to the component and/or the assembly of the first image plane can be overlaid. As settings, for example actual and/or desired values of the current operation would be possible. The other information could include, for example, maintenance information.

It is advantageous for the second image plane to be displayable relative to the first image plane in the foreground to reproduce the information to the image of the first image plane particularly clearly. Preferably, this variant can be retrieved either automatically or by a certain command.

Advantageously, the operating element furthermore comprises a camera, so that the image of the device can be displayed in the first image of the display panel by means of the camera in real time. Thus, the display panel of the operating element reproduces the objects detected by the camera close to reality.

It is particularly advantageous if the information to be displayed in the second image can be displayed depending on operating parameters and/or default settings of the device and/or the operating element. This permits to point out particularly important information or to hide less important information.

In a particularly advantageous variant of the invention, it is possible to detach the operating element from the device and to move it freely relatively to the device. A user of the device is thus not bound to a certain place of the device but can freely move with respect to it. It is here conceivable that the operating element is connected to the device via a line, for example a data cable, and communicates with the latter via the line.

It is particularly advantageous if the device and/or the operating element are adapted for wireless bidirectional communication. This permits the operating element to transmit data to the device and furthermore permits the device to transmit data to the operating element. It is moreover conceivable that the wireless bidirectional communication takes place between the operating element and further devices of the food-processing process.

Advantageously, the position detection device is formed by cooperation of the camera with markers and/or reference images of the device attached to the device. If reference images to the device are stored in a storage module of an electronic control, by image comparison of the current image, for example a camera image, with the reference images, the current orientation and/or position of the operating element relative to the device can be determined.

It revealed to be advantageous if the kind of representation and/or the extent of information to be displayed can be adjusted by means of the operating element. Thus, the user himself/herself can decide which information he wishes to represent in what manner, or whether he would like to do without a representation. It is thus possible to adapt the information content for different operating modes of the device by corresponding adjustment.

The method according to the invention is characterized in that the position and/or the orientation of the operating element relative to the device is/are determined by a position detection device. Furthermore, an output of information for the operation and/or diagnosis of the device is accomplished depending on the determined position.

It is advantageous for the device or its components to be displayed in a first image of a display panel of the operating element, and furthermore for the information for the operation and/or diagnosis of the device to be represented in a second image of the display panel. Thus, the representation of the device is extended by further helpful information, and the operation of the device becomes more intuitive.

Below, advantageous embodiments of the invention will be illustrated more in detail with reference to drawings. The figures show in detail:

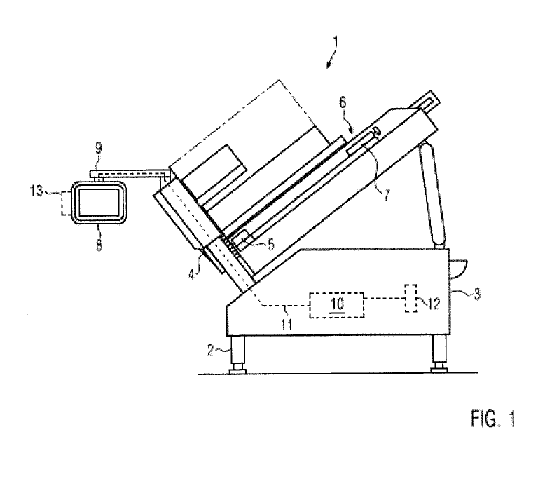

FIG. 1 a device according to the invention in the form of a cutting machine in a side view,

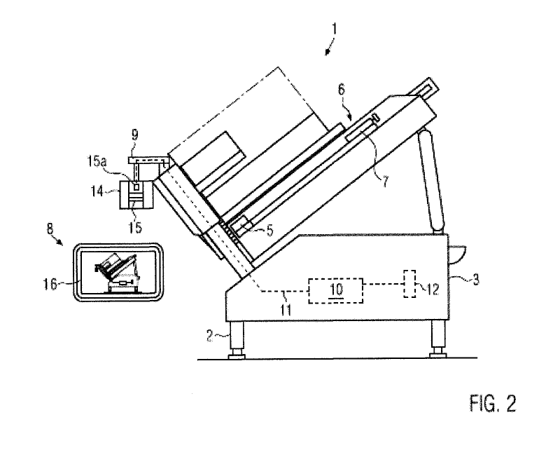

FIG. 2 a further side view of the device according to the invention,

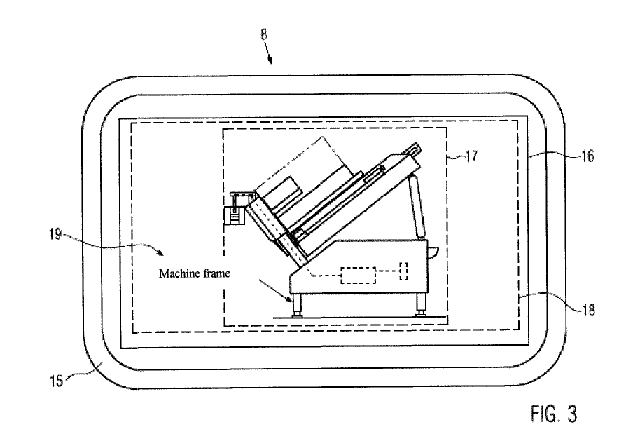

FIG. 3 an operating element of the device according to the invention in a front view, and

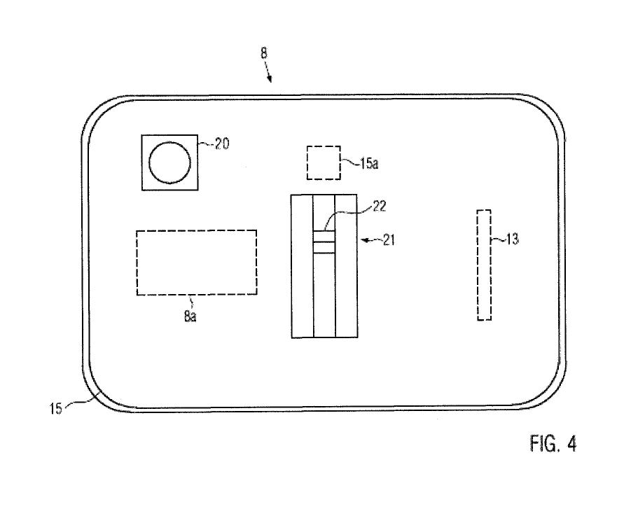

FIG. 4 the operating element of FIG. 3 in a rear view.

Equal components are always provided with the same reference numerals in the figures.

FIG. 1 shows a device 1 according to the invention for processing and/or transporting food products in a side view. In this embodiment, the device 1 is represented in the form of a cutting machine, which is also known as a so-called slicer. These slicers are in particular used for cutting sausage and cheese.

The device 1 comprises a machine frame 2 which bears the device 1. To protect the device from environmental influences, it is enclosed by a housing 3. The device 1 embodied here as a cutting machine furthermore comprises a rotating circular knife 4 by means of which a food product 5, in particular sausage or cheese, can be cut. For supplying the food product 5 to be cut, the device 1 furthermore comprises a product feed 6 with a product holder 7 by the feed motion of which the food product 5 is transported towards the circular knife 4.

For monitoring and controlling the device 1, it has an operating element 8 with an integrated microcontroller 8a and a position sensor 8b mounted at a supporting arm 9. The operating element 8 can be fixed to the supporting arm 9 by a suited bearing which permits a pivoting and/or rotation about several axes of the operating element 7 and relative to the device 1. This can be, for example, a ball head (not represented). It is also possible that the operating element 6 can be rotated about a vertical axis relative to the supporting arm 9.

The device 1 furthermore comprises a control unit 10 which is disposed within the housing 3 protected from environmental influences. The control unit 10 is a programmable microcontroller which includes several inputs and outputs. The operating element 8 and the control unit 10 are connected to each other by a data cable 11, so that the operating element 8 can directly bidirectionally exchange data with the control unit 10.

For a wireless data connection, for example with the operating element 8, the control unit 10 is connected with an antenna 12. The control unit 10 and/or the antenna 12 and/or the operating element 13 can be adapted to communicate with each other via communication protocols. For a wireless communication with the device 1 or the control unit 10, respectively, the operating element 8 therefore has an integrated antenna 13.

FIG. 2 shows a further side view of the device 1 according to the invention where the operating element 8 is detached from the supporting arm 9. One can clearly see that the operating element 8 is held by a receiving plate 14, also referred to as docking station. The receiving plate 14 furthermore has several pins 15 which are electrically conductive and provided for the voltage supply of the operating element 8 and/or the data communication with the latter. In the proximity of the receiving plate 14 or the supporting arm 9 or the (non-depicted) ball head, the device 1 furthermore comprises a position detection device 15a in the form of a sensor. The position detection device 15a is adapted to determine the current orientation of the operating element 8 relative to the device 1 and/or to the supporting arm 9, and it is furthermore adapted for communication with the operating element 8 and/or the control unit 10.

The operating element 8 has a shock-proof housing 15 and a display panel 16. The antenna 13 can be integrated in the housing 15. The display panel 16 is a touch-sensitive monitor which can simultaneously display characters and images and process user inputs. In the shown example, an image of the device 1 is displayed in the display panel 16 of the operating element 8.

FIG. 3 shows an enlarged representation of the operating element 8 in a front view. One can clearly see that the display panel is adapted to represent two images simultaneously. A first image 17 shows the image of the device 1. A second image 18 which superposes the first image 17 represents information 19. The second image 18 thus supplements the first image 17 by the additional information 19. The contents or extent of information 19 can be, for example, details of the operating instructions with explanations to the device 1 and its components to support the service personnel responsible of repair or maintenance. However, these can also be current operational data of the device 1, such as settings or the current speed of the circular knife 4.

FIG. 4 shows the operating element of FIG. 3 in a rear view. The operating element has a camera 20 at its back side. Furthermore, the operating element has a contact bar 21 with pins 22 which are adapted for cooperation with the receiving plate 14 and the pins 15. The pins 22 serve, for example, the voltage supply of the operating element 8 and the data communication with the device 1.

The general functioning of the device 1 according to the invention will be briefly illustrated below.

As long as the operating element 8 is stationarily mounted at the device 1 or supported by the receiving plate 14, the detection of the current orientation or position of the operating element 8, respectively, relative to the device or to the supporting arm 9 is accomplished stationarily by the position detection device 15a embodied as a sensor.

Depending on the pivoting angle and/or the angle of rotation of the operating element 8, the display panel 16 of the operating element 8 can represent the device 1 or certain components of it, i.e. details of the device 1, in the first image 17. The shown image can be already stored in a (non-depicted) memory of the microcontroller 8a of the operating element 8 and/or in the control unit 10.

In a further configuration, the representation in the first image 17 of the display panel 16 is a real-time representation of the device 1 optically detected by the camera 20. A user of the device 1 rotates or pivots the operating element 8 about the device 1, the camera 20 being oriented towards the device. In the first image 17, the device 1 or a part of it is displayed. Depending on the position and orientation of the operating element 8 determined by the position detection device 15a, the first image 17 is superposed by the second image 18 which contains information 19 to the part of the device 1 displayed in the first image 17. The user can determine the displayed information 19 in advance. He/She can choose, for example, between a production mode in which he/she obtains information about the production, such as the cutting guidance or processing speed, and a diagnosis mode which mainly contains information for the maintenance or repair of the device 1.

If the operating element 8 is detached from the receiving plate 14 and thus from the device 1, as is shown in FIG. 2, the position detection or the determination of the current orientation of the operating element 8 is accomplished by means of further applicable or configurable mechanisms. Position detection can then be accomplished by the sensor 8b integrated in the operating element 8.

Starting from the represented embodiment, the device 1 according to the invention can be modified in many ways. The operating element 8 can be adjusted, for example, such that the position detection is done by comparing camera images of the camera 20 and appropriate reference images.

Furthermore, position detection could be done by means of easily detectable markers (not represented) which are arranged on the device 1.

It is furthermore conceivable that the operating element 8 communicates with a plurality of food-processing devices and can control or diagnose them.

The information 19 could be images, for example exploded drawings, of internal parts of the device 1 to supply the service personnel with helpful information.

1. Device (1) for processing and/or transporting food products with an operating element (8) controlling the device (1), wherein the position of the operating element (8) relative to the device (1) is variable,
characterized in that
the current position and/or the orientation of the operating element (8) relative to the device (1) can be detected by a position detection device (15a), and that information (19) for the operation and/or diagnosis of the device (1) can be displayed to a user by the operating element (8) depending on the determined position.

2. Device according to claim 1, characterized in that the information (19) can be displayed to the user by the operating element (8) visually and/or audibly and/or sensibly.

3. Device according to claim 1 or 2, characterized in that the operating element (8) is adapted for communication with further food-processing devices.

4. Device according to one of the preceding claims, characterized in that the operating element (8) is stationarily mounted at the device (1), where the operating element (8) can be swiveled and/or rotated relatively to the device (1).

5. Device according to one of the preceding claims, characterized in that the operating element (8) furthermore comprises a display panel (16) by which at least two different images (17, 18) can be simultaneously displayed.

6. Device according to claim 5, characterized in that the display panel (16) is a touch-sensitive monitor for simultaneous image reproduction and user input.

7. Device according to one of claim 5 or 6, characterized in that in a first image (17) of the display panel (16), an image of the device (1) or of components of the device (1) can be displayed, and the information (19) to the device (1) can be displayed in a second image (18).

8. Device according to claim 7, characterized in that the first image (17) and the second image (18) can be superposed to supplement the first image (17) with the information (19) of the second image (18).

9. Device according to claim 7 or 8, characterized in that the operating element (8) furthermore comprises a camera (20), and that the image of the device (1) can be displayed in real time in the first image (17) of the display panel (16) by means of the camera (20).

10. Device according to one of claims 7 to 9, characterized in that the information (19) to be displayed in the second image can be displayed depending on operating parameters and/or default settings of the device (1) and/or of the operating element (8).

11. Device according to one of the preceding claims, characterized in that the operating element (8) can be detached from the device (1) and is furthermore freely movable relatively to the device (1).

12. Device according to one of the preceding claims, characterized in that the device (1) and/or the operating element (8) is/are adapted for wireless bidirectional communication.

13. Device according to one of claims 9 to 12, characterized in that the position detection device (15a) is formed by cooperation of the camera (20) with markers and/or reference images of the device (1) attached to the device (1).

14. Device according to one of the preceding claims, characterized in that the kind of representation and/or the extent of information (19) to be represented can be adjusted by means of the operating element (8).

15. Method of operating a device (1) with an operating element (8) controlling the device (1), characterized in that the position and/or orientation of the operating element (8) relative to the device (1) are determined by means of a position detection device (15a), and that an output of information (19) for operating and/or diagnosing the device (1) is done depending on the determined position.

16. Method according to claim 15, characterized in that the device (1) or components of it are displayed in a first image (17) of a display panel (16) of the operating element (8), and that furthermore the information (19) for the operation and/or diagnosis of the device (1) are displayed in a second image (18) of the display panel (16).
